(19) United States
(12) Patent Application Publication
(10) Pub. No.: US 2010/0033641 A1
(43) Pub. Date: Feb. 11, 2010

(54) IMAGE DISPLAY DEVICE

(75) Inventors: Shinya Ogasawara, Hyogo (JP); Yukihiro Iwata, Osaka (JP); Takayuki Furukawa, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Osaka (JP)

(21) Appl. No.: 12/490,682

(22) Filed: Jun. 24, 2009

(30) Foreign Application Priority Data
Aug. 8, 2008 (JP) 2008-205051

(51) Int. Cl. H04N 5/64

(52) U.S. Cl. 348/836; 348/E05.128

(57) ABSTRACT

The image display device of the present invention includes a display panel having a front surface for displaying an image and a rear surface facing a side opposite to the front surface, and a chassis to which a circuit-bearing member is attached. The chassis supports the display panel. The chassis has a frame shape that surrounds the display panel from outside in a direction perpendicular to a thickness direction of the display panel, and that allows the rear surface of the display panel to be exposed. Thereby, heat can be radiated to air directly from the rear surface of the display panel.

### BACKGROUND OF THE INVENTION

1. Field of the Invention

The present invention relates to an image display device for displaying images, such as television images.

2. Related Background Art

Image display devices for displaying images, such as television images, have a reduced thickness in recent years. Accordingly, instead of conventional CRTs, flat-panel displays (FPDs) using a flat display panel, such as a plasma display panel and a liquid crystal panel, have become a mainstream for the image display devices.

FIG. 11 and FIG. 12 show a conventional plasma display device, for example. In this plasma display device, a plasma display panel (referred to as a “PDP” hereinafter) 11 for displaying images, and a chassis 12 supporting the plasma display panel at its front are accommodated in a space enclosed by a front cover 16 to which a front filter 15 is joined, and a back cover 14. A circuit board 13a for a power source, a pair of circuit boards 13b, arranged right and left, for driving the PDP, a plurality of data drivers 13c laid out linearly and horizontally, and a tuner block 13d disposed further behind the data driver 13c are fixed at a rear side of the chassis 12. The circuit board 13a, the circuit boards 13b, the data drivers 13c, and the tuner block 13d are attached to a rear surface of the chassis 12, via bosses projecting from the rear surface of the chassis 12, and thereby a clearance is formed between the rear surface of the chassis 12 and each of these.

The chassis 12 plays not only a role of supporting the PDP 11 but also a role of allowing the PDP 11 to radiate heat and to have a uniform temperature. Also, the chassis 12a serves as an electric ground. The chassis 12 usually is made of aluminum with satisfactory thermal and electrical conductivities.

A fan 18 is provided at an upper part of the plasma display device in order to cool the entire device. When the fan 18 is operated, outside air is taken in through an inlet 14a provided in a lower portion of the back cover 14, and hot air in the display is discharged through an outlet 14b provided in an upper portion of the back cover 14. Thereby, air ventilation is carried out, and the entire device is cooled.

The plasma display displays images by gas discharge in the PDP 11. Accordingly, the PDP 11 tends to have a high temperature easily. The high temperature of the PDP 11, however, causes adverse effects, such as hindering normal discharge, because an electric capacity of an electrode formed in the PDP 11 is changed by the high temperature. In light of this, it is preferable to maintain the temperature of the PDP 11 equal to or lower than a predetermined temperature (70° C. to 80° C., for example).

In conventional plasma display devices, however, it is difficult to reduce the temperature of the PDP 11 for reasons, including that an increased volume of electric power is supplied to the PDP 11 in order to raise the intensity of the PDP 11, and that the data drivers 13c provided in close contact with the PDP 11 consume a large amount of power.

To deal with this, as shown in FIG. 11, JP 2002-150954 A, for example, proposes to insert a heat conduction sheet 19 made of a resin with high heat conductivity between the PDP 11 and the chassis 12 so that the heat generated in the PDP 11 is conducted effectively to the chassis 12 via the heat conduction sheet 19. Thereby, the heat is radiated satisfactorily to the space enclosed by the chassis 12 and the back cover 14, allowing the temperature of the PDP 11 to be reduced. Moreover, since the heat conduction sheet 19 allows the PDP 11 to have a uniform temperature, temperature variation in the PDP 11 also can be reduced.

However, the plasma display device of JP 2002-150954 A is the same in that the heat generated in the PDP 11 is radiated from the chassis 12 to the space enclosed by the back cover 14. Since the chassis 12 supports the PDP 11, it has a relatively large thickness to ensure mechanical strength. The heat radiation from the chassis 12 deteriorates the radiation efficiency because it is performed through the chassis 12, that is, because the heat is conducted through the chassis 12. A similar problem may occur on display panels other than the PDP.

### SUMMARY OF THE INVENTION

In view of the foregoing, the present invention is intended to provide an image display device capable of enhancing the efficiency in the heat radiation of the display panel so as to lower the temperature of the display panel.

In order to attain this purpose, the present invention provides an image display device including a display panel having a front surface for displaying an image and a rear surface facing a side opposite to the front surface, and a chassis to which a circuit-bearing member is attached. The chassis supports the display panel. The circuit-bearing member gives the display panel an electrical signal based on image data. The chassis has a frame shape that surrounds the display panel from outside in a direction perpendicular to a thickness direction of the display panel, and that allows the rear surface of the display panel to be exposed.

The present invention makes it possible to expose widely the rear surface of the display panel by employing a simple configuration in which a frame-shaped chassis is adopted. Accordingly, it is possible to radiate heat directly from the rear surface of the display panel to the air, enhancing the radiation efficiency. As a result, the temperature of the display panel can be lowered effectively.

### BRIEF DESCRIPTION OF THE DRAWINGS

FIG. 1 is a schematic vertical cross-sectional view showing the image display device according to Embodiment 1 of the present invention.

FIG. 2 is an exploded perspective view of the image display device shown in FIG. 1.

FIG. 3 is a perspective view showing a PDP fitted inside a chassis.

FIG. 4 is a cross-sectional view showing the chassis of Modified Example.

FIG. 5 is a schematic vertical cross-sectional view showing the image display device according to Embodiment 2 of the present invention.

FIG. 6 is an exploded perspective view of the image display device shown in FIG. 5.

FIG. 7 is a schematic vertical cross-sectional view showing the image display device according to Embodiment 3 of the present invention.

FIG. 8A is an exploded perspective view of the image display device shown in FIG. 7, and FIG. 8B is an enlarged perspective view of fans and a bracket.

FIG. 9 is a cross-sectional view showing the image display device of Modified Example.

FIG. 10A is a rear view of the chassis and the PDP with a crosspiece provided inside the chassis, and FIG. 10B is a cross-sectional view of these.

FIG. 11 is a schematic vertical cross-sectional view showing a conventional plasma display device.

FIG. 12 is a rear view of the conventional plasma display device from which a back cover is omitted.

### DETAILED DESCRIPTION OF THE INVENTION

Hereinafter, the preferred embodiments for carrying out the present invention will be described with reference to the accompanying drawings. It should be noted, however, that the embodiments described below are merely exemplary of the present invention, and should not be construed to limit the scope of the present invention.

### Embodiment 1

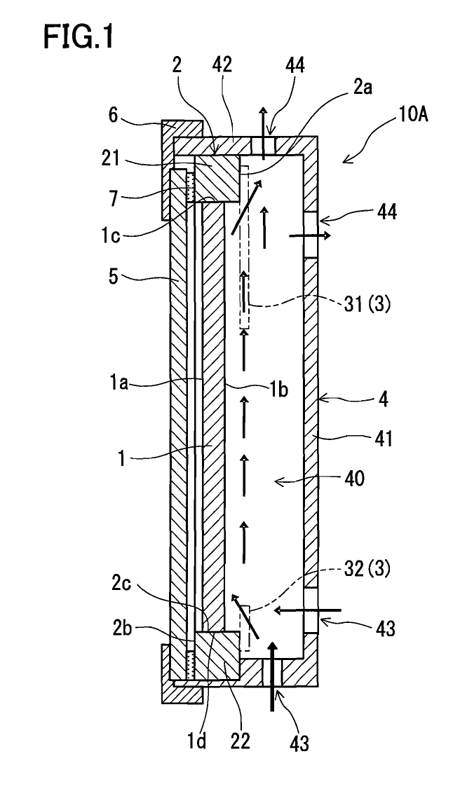

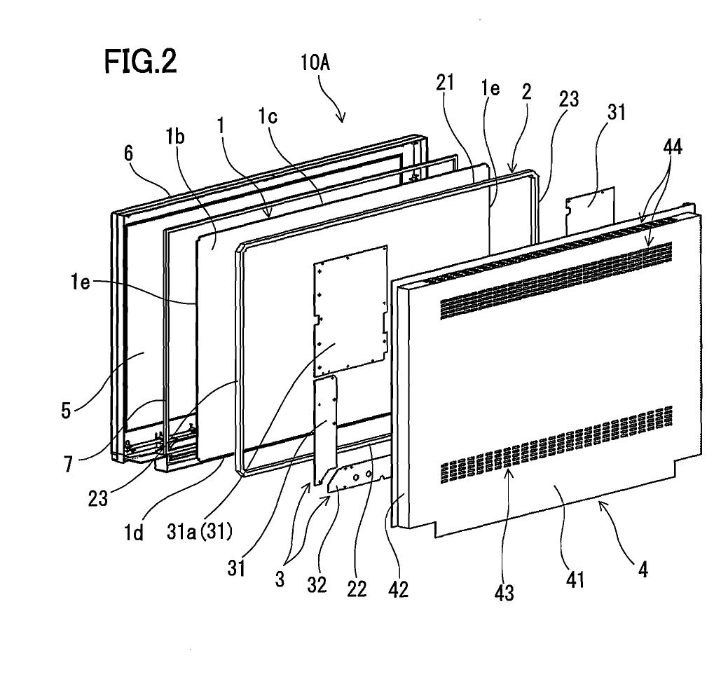

FIG. 1 and FIG. 2 show an image display device 10A according to Embodiment 1 of the present invention. The image display device 10A is a plasma display device, and includes a PDP (a display panel) 1 with a front surface 1a for displaying images, and a rear surface 1b facing a side opposite to the front surface 1a. Furthermore, the image display device 10A includes a chassis 2 supporting the PDP 1, a plurality of circuit-bearing members 3 attached to the chassis 2, a back cover 4 covering the circuit-bearing members 3 from a rear side of the PDP 1, a front filter 5 disposed at a front side of the PDP 1, and a front cover 6 covering a peripheral portion of the front filter 5 from the front side of the PDP 1.

The PDP 1 has a rectangular shape, and usually is oriented so that a longitudinal direction thereof becomes a horizontal direction, and a short direction thereof becomes a vertical direction. For easy explanation, the front surface 1a side is referred to as a front side, and the rear surface 1b side is referred to as a rear side in a thickness direction of the PDP 1 in the specification. In the longitudinal direction, one side (lower-left side in FIG. 2) is referred to as a right side, and another side (upper-right side in FIG. 2) is referred to as a left side.

Specifically, the PDP 1 is constituted by bonding together a front glass substrate and a rear glass substrate, which are not shown in detail. A surface of the front glass substrate on a side opposite to the rear glass substrate constitutes the front surface 1a, and a surface of the rear glass substrate on a side opposite to the front glass substrate constitutes the rear surface 1b.

A plurality of display electrode pairs is formed on the front glass substrate. Each of the display electrode pairs consists of a scanning electrode and a sustaining electrode, both extending in the lateral direction (in the longitudinal direction of the PDP 1). A plurality of address electrodes extending in the vertical direction (in the short direction of the PDP 1) is formed on the rear glass substrate. The display electrode pairs are covered by a dielectric layer. The dielectric layer is covered by a protective layer made of MgO or the like. A phosphor colored in red, blue or green is applied on each of the address electrodes. The front glass substrate and the rear glass substrate have a thickness of approximately 1.5 mm to 3 mm, respectively.

A portion (a space) defined between the display electrode pair and the address electrode at a position where the display electrode pair intersects with the address electrode when viewed from the front side is called a discharge cell. The discharge cell is filled with a discharge gas containing a rare gas such as helium (He), neon (Ne), and xenon (Xe). Applying a voltage to the display electrode pairs as well as the address electrodes causes an electric discharge in the discharge cells, generating ultraviolet rays. The ultraviolet rays thus generated excite the phosphor to emit light. Thus, an image is displayed.

Specifically, the image display process proceeds as follows. First, an initialization discharge is performed, in which a voltage is applied to all lines of the scanning electrodes to cause an electric discharge in all of the discharge cells. Next, a voltage is applied to the scanning electrodes in order, while a voltage is applied also to the address electrodes crossing the discharge cells desired to emit light on the voltage-applied scanning electrodes. This is called an address discharge. Thereby, the discharge cell located at an intersection between the voltage-applied scanning electrode and the voltage-applied address electrode emits light, and the discharge cell is selected as a light-emitting cell. Then, a sustaining discharge is performed, in which an alternating voltage is applied to the scanning electrodes and the sustaining electrodes. The sustaining discharge allows only the previously selected light-emitting cells to emit light so that the PDP 1 displays an image.

When the PDP 1 displays an image by causing discharge in the discharge cells, the temperature of the PDP 1 itself becomes high easily. The high temperature of the PDP 1 causes erroneous discharges, such that the discharge cell desired to emit light fails to do so, and the discharge cell desired not to emit light emits light, because the discharge characteristics of the PDP 1 are changed by the high temperature. Accordingly, the quality in displaying images is deteriorated. The high temperature of the PDP 1 also raises problems, such as breakage of the front glass substrate and the rear glass substrate. Therefore, it is important to dissipate efficiently the heat generated in the PDP 1 and suppress the temperature of the PDP 1 to be low, for example, 70° C. to 80° C.

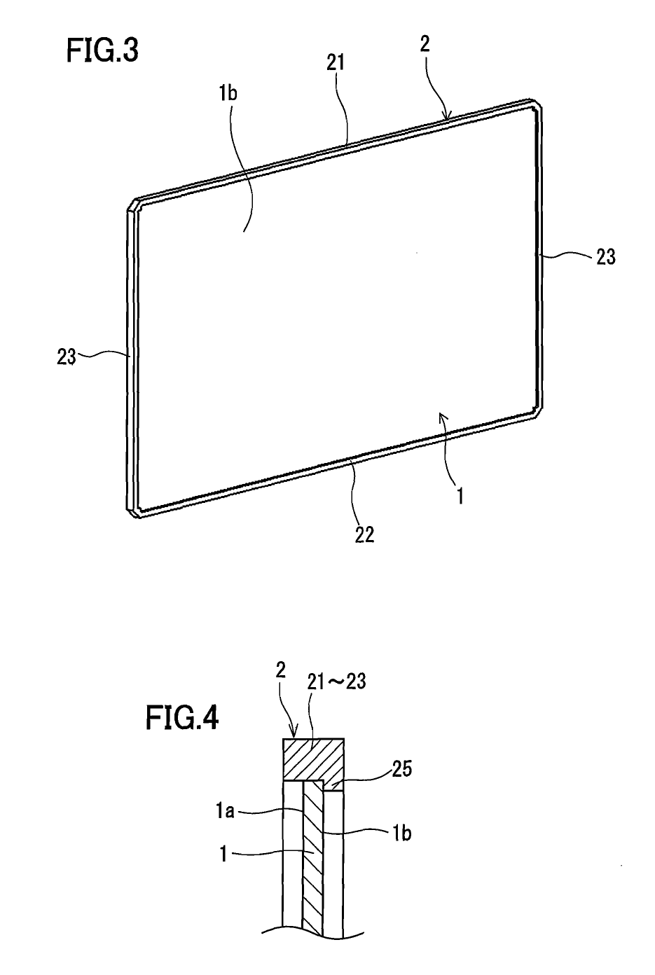

The chassis 2 has a frame shape that surrounds the PDP 1 from outside in the direction perpendicular to the thickness direction of the PDP 1, and that allows the rear surface 1b of the PDP 1 to be exposed. More specifically, the PDP 1 is fitted inside the chassis 2 as shown in FIG. 3, and end surfaces 1c to 1e (see FIG. 2) forming an outer peripheral surface of the PDP 1 are supported by the chassis 2. The chassis 2 preferably is made of metal with high heat and electric conductivities, such as aluminum and copper. The chassis 2 may be made of iron or stainless steel depending on the power consumption of the PDP 1. The chassis 2 also may have a structure in which different kinds of metals are combined.

Specifically, the chassis 2 has an upper side portion 21 and a lower side portion 22 both extending in a horizontal direction while being in contact with the upward-facing end surface 1c and the downward-facing end surface 1d of the PDP 1, and a pair of lateral side portions 23 extending in a vertical direction while being in contact with a pair of the end surfaces 1e of the PDP 1 facing left and right, respectively. Although each of the side portions 21 to 23 has a rectangular cross section in the present embodiment, it may have a shape with a projecting portion 25 touching the rear surface 1b of the PDP 1, as shown in FIG. 4, for example.

The chassis 2 is designed to have a thickness in a front-rear direction sufficiently larger than that of the PDP 1. In the present embodiment, the PDP 1 is disposed at an approximate center of the chassis 2 in the front-rear direction. Accordingly, a front end surface 2b of the chassis 2 is located further forward than the front surface 1a of the PDP 1, and a rear end surface 2a of the chassis 2 is located further backward than the rear surface 1b of the PDP 1. The PDP 1 may be fixed to an inner peripheral surface 2c of the chassis 2 by an adhesive, etc.

The circuit-bearing members 3 give the PDP 1 an electrical signal based on image data. In the present embodiment, the circuit-bearing members 3 include circuit boards 31 for driving the PDP, and a data driver 32. The circuit boards 31 for driving the PDP are connected electrically to the data driver 32. Among the circuit boards 31, an upper right circuit board 31a includes a power supply component in the present embodiment.

The circuit boards 31 and the data driver 32 each have a plate-like shape, and are attached to the rear end surface 2a of the chassis 2 by plane contact. This allows each of the circuit-bearing members 3 to face the rear surface 1b of the PDP 1 while being spaced apart therefrom. Specifically, the circuit boards 31 are fixed to the lateral side portions 23 and the upper side portion 21 of the chassis 2, and the data driver 32 is fixed to the lower side portion 22 of the chassis 2. The circuit board 31 fixed to the upper side portion 21 may have an opening or a cut-out to prevent heat from staying between the circuit board 31 and the PDP 1.

A back cover 4 has a container-like shape that opens toward the front side, and is fixed to the chassis 2 from outside in such a manner that the back cover 4 surrounds the circuit-bearing members 3 from the rear side. The rear surface 1b of the PDP 1 faces a cover space 40 enclosed by the back cover 4. Specifically, the back cover 4 has an approximately rectangular bottom wall portion 41, and a side wall portion 42 rising up from a peripheral portion of the bottom wall portion 41. An edge portion of the side wall portion 41 fits in the chassis 2 from outside, and a front cover 6 fits in the edge portion of the side wall portion 41 from further outside. In the present embodiment, both of right and left lower portions of the bottom wall portion 41 are cut out together with the side wall portion 42.

The back cover 4 has conductivity, and blocks radiation of electromagnetic waves emitted from the PDP 1 and the circuit-bearing members 3. The back cover 4 may be formed by pressing a metal plate. The back cover 4 also may be a resin-mold product with a conductive layer formed inside thereof.

Moreover, the back cover 4 is provided with an inlet 43 for taking air into the cover space 40, and an outlet 44 for discharging air out of the cover space 40. Thereby, ventilation can be performed between outside and inside of the back cover 4. In the present embodiment, the inlet 43 is provided at two locations: a lower portion of the bottom wall portion 41, and a lower portion of the side wall portion 42, and the outlet 44 is provided at two locations: an upper part of the bottom wall portion 41, and an upper part of the side wall portion 42.

The front cover 6 is made of resin, for example. The front cover 6 is a rectangular frame whose central part opens when viewed from the front side. The peripheral portion of the front filter 5 is joined to the front cover 6 from the rear side.

The front filter 5 is designed to be slightly larger than the PDP 1. The peripheral portion of the front filter 5 is pressed against the front end surface 2b of the chassis 2, with a rectangular frame-shaped conductive cushion 7 interposed therebetween. The front filter 5 has a rectangular transparent substrate made of glass or resin such as acrylic resin, and a various functional films formed on the transparent substrate. Specific examples of the functional films include anti-reflection films, colored films, neon light cutting-off films, near-infrared light cutting-off films, and conductive films. At least a peripheral portion of the conductive film is exposed to the rear side, and this peripheral portion is connected electrically to the chassis 2 via the cushion 7.

Next, description will be made with respect to the heat radiation from the image display device 10A with reference to FIG. 1.

Since the rear surface 1b of the PDP 1 is exposed, air on the surface of the rear surface 1b is expanded thermally by receiving heat from the PDP 1, generating an ascending current in the cover space 40 as shown by the arrows in FIG. 1. The air having ascended in the cover space 40 is discharged to outside eventually through the outlet 44 so as to dissipate heat out of the device. On the other hand, outside air with a relatively low temperature is taken in through the inlet 43. Thus, positioning the inlet 43 and the outlet 44 to take advantage of a chimney effect etc. makes it possible to dissipate heat efficiently by natural convection. Needless to say, the heat dissipation can be further efficient when a fan (not shown) for accelerating the air flow is provided in the vicinity of the outlet 44, for example.

As described above, the image display device 10A of the present embodiment makes it possible to expose widely the rear surface 1b of the PDP 1 by employing a simple configuration in which the chassis 2 has a frame shape. Thereby, the heat can be radiated to the air directly from the rear surface 1b of the PDP 1, enhancing the radiation efficiency. As a result, the temperature of the PDP 1 can be lowered efficiently.

Moreover, arranging the chassis 2 outside the periphery of the PDP 1 allows the PDP 1 to be disposed in a region within the thickness of the chassis 2, allowing the image display device 10A to have a further reduced thickness. In addition, connecting electrically the front filter to the back cover by utilizing the chassis 2 as in the present embodiment makes it possible to constitute an electromagnetic wave shielding structure with a simple configuration.

Furthermore, since the chassis 2 is allowed to have a larger thickness than before, the chassis 2 can have an improved section modulus, and the supporting strength (rigidity against bend and twist) of the PDP 1 can be enhanced.

It is possible to radiate the heat generated in the PDP 1 effectively not only toward the rear surface 1b side, but also in the direction perpendicular to the thickness direction of the PDP 1, via the chassis 2.

A surface treatment for enhancing heat conductivity to the air is applied preferably to the rear surface 1b of the PDP 1. For example, the rear surface 1b of the PDP 1 is roughened by blasting, and a film with a higher conductivity than that of the PDP 1 (the rear glass substrate, to be exact) is stacked on the rear surface 1b of the PDP 1. In order to form such a film with a higher heat conductivity, a resin, such as graphite (heat conductivity: up to around 800 W/m·K), and a silicone-based mixed coating material (heat conductivity: up to around 200 W/m·K), is applied to the rear surface 1b of the PDP 1. This makes it possible to enhance the heat conductivity to the air, and lower the temperature of the PDP 1 further. Moreover, stacking the film with a higher conductivity than that of the PDP 1 allows the rear surface 1b to have a uniform temperature (this is so-called temperature uniformization), suppressing the deterioration of image quality.

Also, a surface treatment for reflecting the heat radiated from the circuit-bearing members 3 is applied preferably to the rear surface 1b of the PDP 1. Specifically, a metal film with a specular surface (a specular-surfaced metal film) is stacked on the rear surface 1b. The specular surface preferably has a radiation factor of 0.1 or less. The metal film with such a specular surface can be formed by, for example, vapor-depositing, coating, and plating of a metal material. As the metal material, aluminum, nickel, and gold can be used, for example. As the specular-surfaced film, a diamond like carbon film may be used. When thus configured, it is possible to suppress local temperature increase in the PDP 1 caused by the heat radiation from the circuit-bearing members 3. Furthermore, the metal film and the diamond like carbon film allow the rear surface 1b to have a uniform temperature because they have a higher heat conductivity than that of the PDP 1.

### Embodiment 2

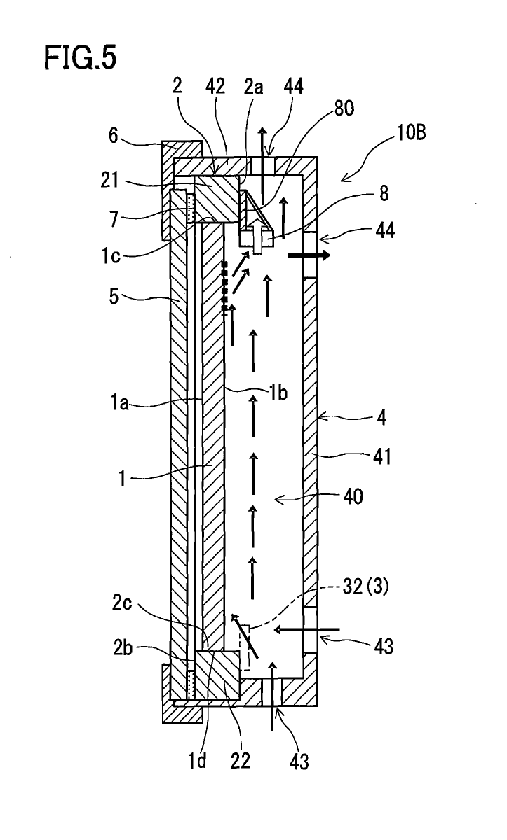

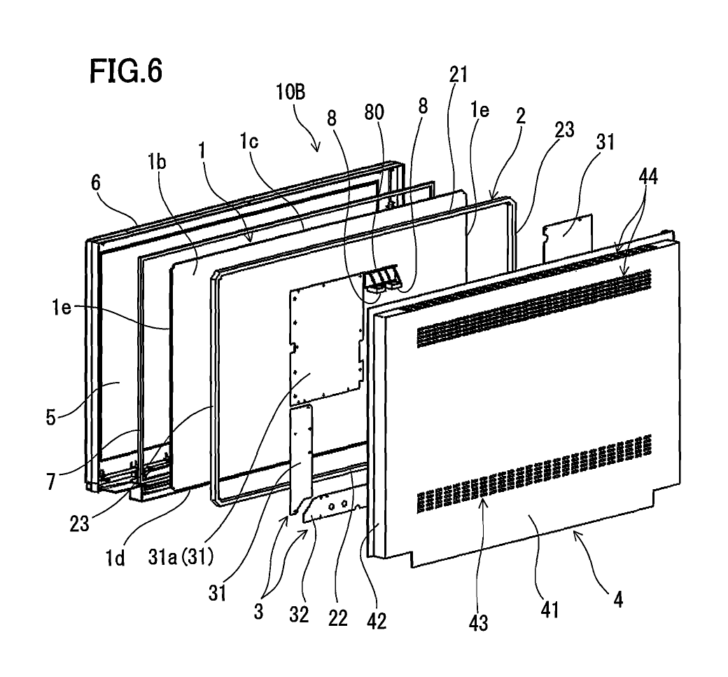

FIG. 5 and FIG. 6 show an image display device 10B according to Embodiment 2 of the present invention. In Embodiment 2 as well as Embodiment 3 to be described later, the same components as those in Embodiment 1 are designated by the same reference numerals, and the description thereof will be omitted.

The image display device 10B of Embodiment 2 is different from the image display device 10A of Embodiment 1 in that fans 8 are disposed in the vicinity of the circuit board 31a for driving the PDP, which also serves as the circuit board for the power source.

Specifically, two of the fans 8 are provided side by side, that is, right and left, in a posture that allows air to flow in an ascending direction. The fans 8 are attached to the upper side portion 21 of the chassis 2 with a bracket 80.

Among the circuit-bearing members 3, the circuit board 31a has a relatively high temperature. The heat radiation from the circuit board 31a makes the rear surface 1b of the PDP 1 have a high temperature locally at a portion facing the circuit board 31a. The image display device 10B of Embodiment 2 cools this high temperature portion actively by arranging the fans 8 in the vicinity of the circuit board 31a. More specifically, when the fans 8 operate, they draw the air between the circuit board 31a and the rear surface 1b of the PDP 1. In other words, the fans 8 force the air to pass through between the circuit board 31a and the rear surface 1b of the PDP 1.

When thus configured, it is possible to reduce the influence exerted by the heat radiation from the relatively high temperature circuit board 31a, and to allow the PDP 1 to obtain a uniform temperature distribution.

### Embodiment 3

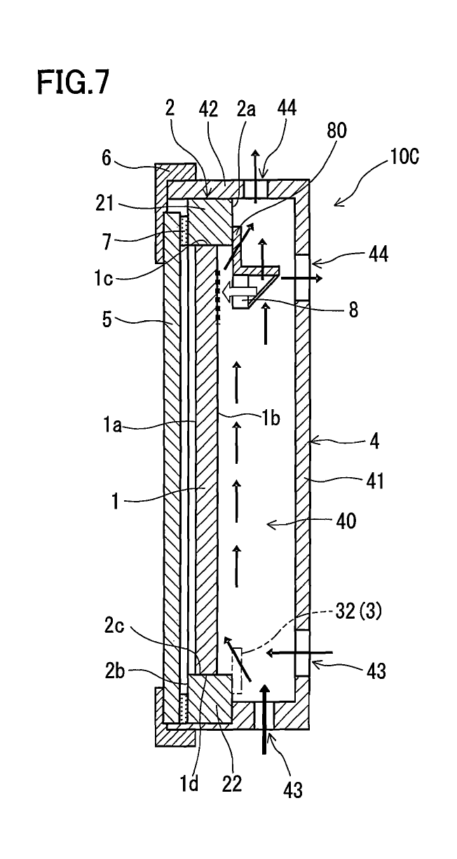

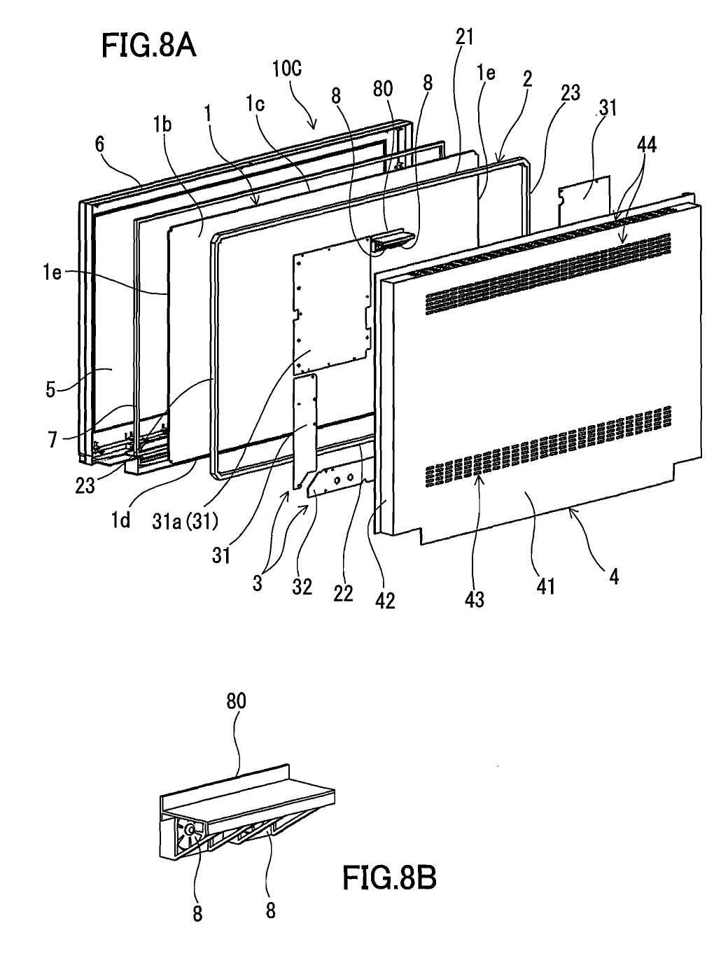

FIG. 7 and FIG. 8A show an image display device 10C according to Embodiment 3 of the present invention. The image display device 10C is the same as the image display device 10B of Embodiment 2 except for the orientation of the fans 8.

More specifically, the fans 8 are oriented to allow air to flow from the rear side to the front side in Embodiment 3. For this purpose, the bracket 80 is designed to have, for example, an approximately L-shaped cross-section as shown in FIG. 8B.

In contrast to Embodiment 2, operation of the fans 8 forces the air between the circuit board 31a and the rear surface 1b of the PDP 1 to flow out in Embodiment 3. More specifically, the fans 8 force air to flow through between the circuit board 31a and the rear surface 1b of the PDP 1.

Accordingly, similar effects to those of Embodiment 2 also can be obtained.

### Modified Example

In each of the embodiments described above, the PDP 1 is disposed at the approximate center of the chassis 2 in the front-rear direction. The PDP 1, however, may be disposed in such a manner that the rear surface 1b is located on the same plane as that of the rear end surface 2a of the chassis 2, for example. In this case, interposing a spacer between the rear end surface 2a and the circuit-bearing members 3 allows the circuit-bearing members 3 to face the rear surface 1b while being spaced apart therefrom. It should be noted, however, that when the rear surface 1b of the PDP 1 is located further forward than the rear end surface 2a of the chassis 2 as in each of the embodiments described above, the circuit-bearing members 3 can be attached directly to the rear end surface 2a of the chassis 2.

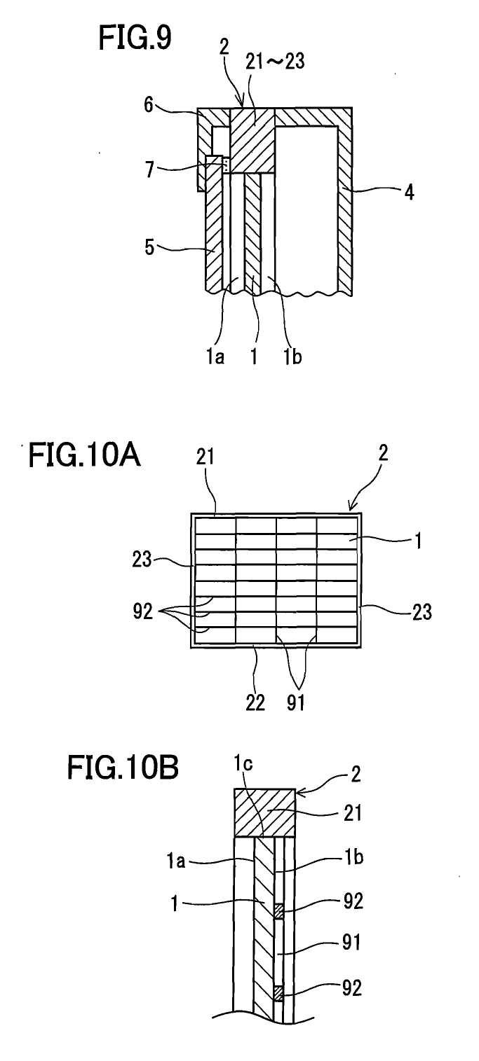

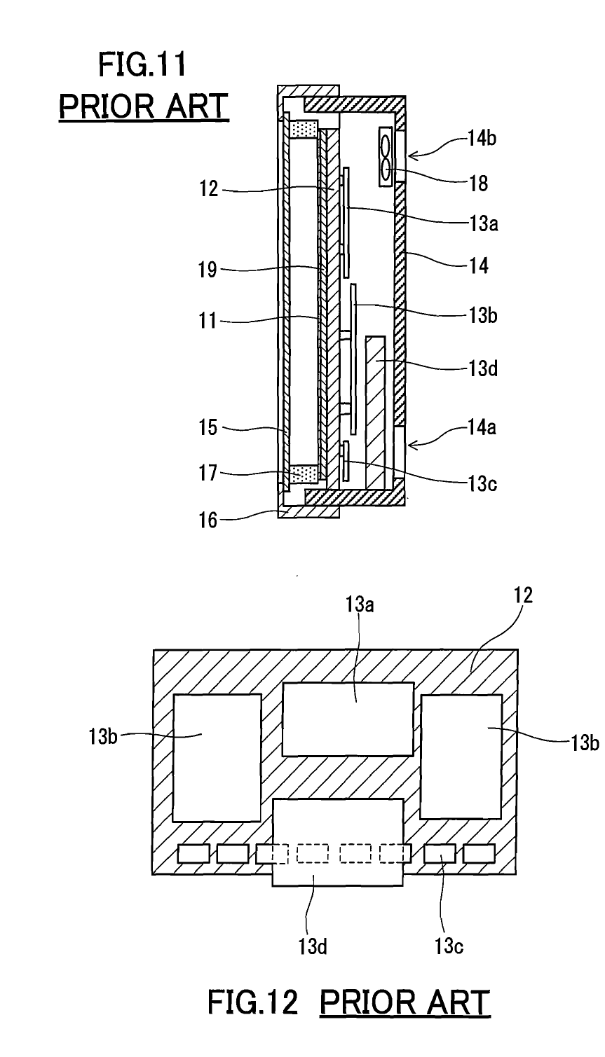

Moreover, although the chassis 2 is fitted inside the back cover 4 in each of the embodiments described above, the chassis 2 may be exposed to outside from between the front cover 6 and the back covers 4 so as to radiate heat from the chassis 2 to the outside directly, as shown in FIG. 9, for example. When thus configured, the radiation efficiency can be improved further.

Furthermore, a plurality of conductive vertical pieces 91 and a plurality of conductive horizontal pieces 92 may be provided inside the chassis 2 as shown in FIG. 10A and FIG. 10B, for example. The vertical pieces 91 bridge between the mutually-facing upper side portion 21 and the lower side portion 22 of the chassis 2, along the rear surface 1b of the PDP 1. The horizontal pieces 92 bridge between the pair of the mutually-facing lateral side portions 23 of the chassis 2, along the rear surface 1b of the PDP 1. The pieces 91 and 92 may be provided integrally with the chassis 2, or may be provided as separate members. When thus configured, a path for return current can be ensured on the rear side of the PDP 1. Also, the number of the fixing points of the circuit-bearing members 3 can increase by utilizing the pieces 91 and 92.

The circuit-bearing member 3 does not need to be provided in a separated form, and may be constituted by a single circuit board.

Instead of providing the front filter 5, a functional film, such as an anti-reflection film, a colored film, a neon light cutting-off film, a near-infrared light cutting-off film, and a conductive film, may be formed on a front surface of the front glass substrate.

The present invention can be applied not only to plasma display devices but also to other image display devices, such as liquid crystal display devices, organic EL devices and inorganic EL devices. More specifically, the display panel of the present invention may be a liquid crystal panel or an EL panel.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

### Features of the Embodiments

Features of the embodiments are listed hereinafter. Features of the present invention are not limited to these.

(1)

The image display device of the present invention includes a display panel having a front surface for displaying an image and a rear surface facing a side opposite to the front surface, and a chassis to which a circuit-bearing member is attached. The chassis supports the display panel. The circuit-bearing member gives the display panel an electrical signal based on image data. The chassis has a frame shape that surrounds the display panel from outside in a direction perpendicular to a thickness direction of the display panel, and that allows the rear surface of the display panel to be exposed.

(2)

A plurality of the circuit-bearing members is provided. Each of the circuit-bearing members faces the rear surface of the display panel while being spaced apart therefrom.

(3)

The chassis has a rear end surface located further backward than the rear surface of the display panel in the thickness direction of the display panel. The circuit-bearing members are attached to the rear end surface.

(4)

The image display device further includes a fan for forcing air to pass through between the rear surface of the display panel and a relatively high temperature circuit-bearing member among the circuit-bearing members.

(5)

The fan is disposed in the vicinity of the relatively high temperature circuit-bearing member among the circuit-bearing members.

(6)

The rear surface of the display panel is roughened.

(7)

A film with a heat conductivity higher than that of the display panel is stacked on the rear surface of the display panel.

(8)

A metal film with a specular surface is stacked on the rear surface of the display panel.

(9)

The image display device further includes a back cover covering the circuit-bearing member from a rear side of the display panel. The rear surface of the display panel faces a cover space enclosed by the back cover.

(10)

The back cover is provided with an inlet for taking air into the cover space, and an outlet for discharging air out of the cover space.

(11)

The image display device further includes a front filter disposed at a front side of the display panel, and a front cover covering a peripheral portion of the front filter from the front side of the display panel.

(12)

The display panel is a plasma display panel.

As having been described, the image display device according to the present invention is effective in lowering the temperature of the display panel. Particularly, it is useful for plasma display devices using a PDP, which is a spontaneous light emitting display panel, and displays using an EL panel.

What is claimed is:

1. An image display device comprising:
a display panel having a front surface for displaying an image and a rear surface facing a side opposite to the front surface; and
a chassis to which a circuit-bearing member is attached, the chassis supporting the display panel, and the circuit-bearing member giving the display panel an electrical signal based on image data,
wherein the chassis has a frame shape that surrounds the display panel from outside in a direction perpendicular to a thickness direction of the display panel, and that allows the rear surface of the display panel to be exposed.

2. The image display device according to claim 1, wherein a plurality of the circuit-bearing members are provided, and each of the circuit-bearing members faces the rear surface of the display panel while being spaced apart therefrom.

3. The image display device according to claim 2, wherein the chassis has a rear end surface located further backward than the rear surface of the display panel in the thickness direction of the display panel, and the circuit-bearing members are attached to the rear end surface.

4. The image display device according to claim 2, further comprising a fan for forcing air to pass through between the rear surface of the display panel and a relatively high temperature circuit-bearing member among the circuit-bearing members.

5. The image display device according to claim 4, wherein the fan is disposed in the vicinity of the relatively high temperature circuit-bearing member among the circuit-bearing members.

6. The image display device according to claim 2, wherein the rear surface of the display panel is roughened.

7. The image display device according to claim 2, wherein a film with a heat conductivity higher than that of the display panel is stacked on the rear surface of the display panel.

8. The image display device according to claim 2, wherein a metal film with a specular surface is stacked on the rear surface of the display panel.

9. The image display device according to claim 1, further comprising a back cover covering the circuit-bearing member from a rear side of the display panel,
wherein the rear surface of the display panel faces a cover space enclosed by the back cover.

10. The image display device according to claim 9, wherein the back cover is provided with an inlet for taking air into the cover space, and an outlet for discharging air out of the cover space.

11. The image display device according to claim 1, further comprising:
a front filter disposed at a front side of the display panel; and
a front cover covering a peripheral portion of the front filter from the front side of the display panel.

12. The image display device according to claim 1, wherein the display panel is a plasma display panel.
